(19) United States
(12) Patent Application Publication
(10) Pub. No.: US 2002/0168312 A1
(43) Pub. Date: Nov. 14, 2002

(54) Pyrogenic oxides doped with potassium

(76) Inventors: Helmut Mangold, Rodenbach (DE); Wolfgang Lortz, Wachtersbach (DE); Rainer Golchert, Dieburg (DE); Helmut Roth, Mainaschaff (DE)

Correspondence Address: VENABLE, BAETJER, HOWARD AND CIVILETTI, LLP, P.O. BOX 34385, WASHINGTON, DC, 20043-9998, US

(21) Appl. No.: 10/020,920

(22) Filed: Dec. 19, 2001

(30) Foreign Application Priority Data
Dec. 23, 2000 (DE) 10065028.7

(51) Int. Cl. C01B 33/12

(52) U.S. Cl. 423/335

(57) ABSTRACT

A method for producing potassium-doped pyrogenic oxides involves mixing a gaseous mixture including a pyrogenic oxide precursor and an aqueous aerosol containing a potassium salt to form an aerosol-gaseous mixture which is then reacted in a flame under conditions suitable for producing pyrogenic oxides by flame oxidation or flame hydrolysis to form the potassium-doped pyrogenic oxides product. The particle product is spherical, has a BET surface between 1 and 1000 m²/g and a narrow distribution of particle size of at least 0.7. The doped oxides can be used as polishing material (CMP application).

### BACKGROUND OF THE INVENTION

1. Field of the Invention

The invention is relative to pyrogenic oxides doped by means of aerosol with potassium, to the method of their production and to their usage.

2. Description of Related Art The doping of pyrogenic oxides by means of aerosol is described in DE 196 50 500. It shows how an aerosol is additionally fed into a flame in which a pyrogenic oxide is produced by flame hydrolysis.

A salt of the compound(s) to be doped is in this aerosol.

It was found that when potassium salts are used as doping component the structure, that is, the degree of intergrowth and also the morphology (that is, the outward image) of the primary particles, is decisively changed. According to the invention this change of the morphology begins at a potassium content of more than 0.03% by wt.

### SUMMARY OF THE INVENTION

Subject matter of the invention is constituted by pyrogenically produced oxides of metals or metalloids which oxides are doped by means of aerosol with potassium and are characterized in that the base component is an oxide that is pyrogenically produced in the manner of flame oxidation or preferably of flame hydrolysis and is doped with potassium of more than 0.03 to 20% by wt. and in that the doping amount is preferably in a range of 500 to 20,000 ppm, the doping component is a salt of potassium and the BET surface of the doped oxide is between 1 and 1000 m²/g.

The breadth of the distribution of particle size is defined as the quotient dₙ/dₐ with dₙ as arithmetic particle diameter and dₐ the average particle diameter over the surface. If the quotient dₙ/dₐ has the value of 1, a monodisperse distribution is present. That is, the closer the value is to 1 the closer the distribution of particle size is.

The close distribution of particle size, defined by the value dₙ/dₐ, assures that no scratches are caused by large particles during the chemical-mechanical polishing.

The average particle size can be less than 100 nanometers and the breadth of the distribution of particle size is at least 0.7.

The oxide can preferably be silicon dioxide. The pH of the doped, pyrogenic oxide, measured in a 4% aqueous dispersion, can be more than 5, preferably from 7 to 8. The BET surface of the doped oxide can be between 1 and 1000 m²/g, preferably between 60 and 300 m²/g.

The (DBP number) dibutylphthalate absorption can not show any measurable end point and the BET surface of the doped oxide can be between 1 and 1000 m²/g.

Further subject matter of the invention is constituted by a method of producing the pyrogenic oxides of metals or metalloids, which oxides are doped by means of aerosol with potassium, which is characterized in that an aerosol produced from a potassium salt solution with a potassium chloride content greater than 0.5% by wt. KCl is fed into a flame like the one used to produce pyrogenic oxides, preferably silicon dioxide in the manner of flame oxidation or preferably of flame hydrolysis, that this aerosol is homogeneously mixed before the reaction with the gaseous mixture of flame oxidation or flame hydrolysis, then the aerosol-gaseous mixture is allowed to react in a flame and the pyrogenic, potassium-doped oxides produced are separated in a known manner from the gas flow, that a potassium salt solution containing the potassium salt serves as starting product of the aerosol and that the aerosol is produced by atomization by means of an aerosol generator preferably in accordance with the gas-atomizing (two-fluid) nozzle method.

The method of producing pyrogenic oxides such as, e.g., silicon dioxide is known from Ullmann's Encyclopädie der technischen Chemie, 4^{th} edition, volume 21, page 464 (1982). In addition to silicon tetrachloride any liquefiable compound of silicon such as, e.g., methylmonochlorosilane can be used as starting material.

DE 196 50 500 teaches a method of producing silicon dioxide doped with aerosol.

In the method of the invention oxygen can be additionally added.

The silicon dioxide in accordance with the invention and doped with potassium by means of aerosol exhibits a distinctly narrower distribution of particle size curve than the known silicon dioxide. It is particularly suitable for this reason for use as an abrasion means in CMP (chemical mechanical polishing). The potassium is uniformly distributed in the case of the silicon dioxide of the invention. It can not be localized on EM photographs.

The pyrogenic oxides doped in this manner with potassium surprisingly exhibit spherical, round primary particles in an electron microscope image that are only slightly intergrown with each other, which is expressed in the fact that no end point can be recognized in a “determination of structure” according to the DBP method. Furthermore, highly filled dispersions with a low viscosity can be produced from these pyrogenic powders doped with potassium.

Further subject matter of the invention is constituted by the use of pyrogenic oxides doped with potassium by means of aerosol as filler, carrier material, catalytically active substance, starting material for producing dispersions, as polishing material (CMP applications), base ceramic material, in the electronic industry, in the cosmetic industry, as additive in the silicon industry and rubber industry, for adjusting the rheology of liquid systems, for the stabilization of heat protection and in the paint industry.

### BRIEF DESCRIPTION OF THE FIGURES

FIG. 1 shows an EM photograph of the pyrogenic silicic acid of reference example 1 (without doping).

FIG. 2 shows an EM photograph of the pyrogenic silicic acid according to example 2 doped with potassium.

FIG. 3 shows the DBP curve of the powders of reference example 1 (weighed portion 16 g): The take-up of force and the measured torque (in Nm) of the rotating blades of the DBP measuring device (Rheocord 90 of the company Haake/Karlsruhe) shows a sharply pronounced maximum with a subsequent decline at a certain addition of DBP. This curve form is characteristic for known pyrogenic oxides that are not doped.

FIG. 4 shows the DBP curve of the powder of the pyrogenic oxide doped with potassium in accordance with the invention (16 g weighed portion) according to example 2.

FIG. 5 shows the electron microscope photograph of the powder of example 3 with an enlargement of 1:50000.

FIG. 6 shows the electron microscope photograph of the powder of example 3 with an enlargement of 1:100000.

FIG. 7 shows the electron microscope photograph of the powder of example 3 with an enlargement of 1:200000.

FIG. 8 shows the results of the particle count of the powders of example 1.

FIG. 9 shows the results of the particle count of the powders of example 1.

FIG. 10 shows the results of the particle count of the powders of example 1.

FIG. 11 shows the results of the particle count of the powders of example 7.

FIG. 12 shows the results of the particle count of the powders of example 7.

FIG. 13 shows the results of the particle count of the powders of example 7.

### DETAILED DESCRIPTION OF THE INVENTION

The subject matter of the invention will be explained and described in detail using the following examples:

A burner arrangement is used like the one described in DE OS 196 50 500.

### EXAMPLE 1

### Reference Example Without Doping with Potassium Salts but with Water Vapor

4.44 kg/h SiCl₄ are evaporated at approximately 130° C. and transferred into the central tube of the burner with a known design in accordance with DE 196 50 500 A1. 2.9 Nm³/h hydrogen as well as 3.8 Nm³/h air and 0.25 Nm³/h oxygen are additionally fed into this tube. This gaseous mixture flows out of the inner burner nozzle and burns into the combustion chamber of the water-cooled fire tube. Additionally, 0.3 Nm³/h (secondary) hydrogen and 0.3 Nm³/h nitrogen are fed into the jacket nozzle surrounding the central nozzle in order to avoid cakings.

Approximately 10 Nm³/h air is drawn from the ambient into the fire tube standing under a slight vacuum (open burner operation).

The second gaseous component that is fed into the axial tube consists in this reference example of hydrogen produced by superheating distilled water at approximately 180° C. Two gas-atomizing nozzles with an atomization power of 250 g/h water function thereby as aerosol generator.

The atomized water vapor is conducted with the aid of a carrier gas current of approximately 2 Nm³/h air through heated conduits during which the water-vapor mist turns into gas at temperatures of approximately 180° C.

After the flame hydrolysis the reaction gases and the pyrogenic silicic acid produced are drawn through a cooling system by applying a vacuum and the gaseous particle current cooled off thereby to approximately 100 to 160° C. The solid matter is separated from the current of waste gas in a filter or cyclone.

The pyrogenic silicic acid produced accumulates as white, fine powder. In a further step any adhering remnants of hydrochloric acid are removed from the silicic acid at an elevated temperature by a treatment with air containing water vapor.

The BET surface of the pyrogenic silicic acid is 124 m²/g.

The breadth of the distribution of the particle size is calculated as follows:

dₙ=16.67 nm

dₐ=31.82 nm

The quotient

$${q}_{1} = \frac{{d}_{n}}{{d}_{a}} = 0.52 .$$

The production conditions are summarized in Table 1. The analytical data of the silicic acid obtained is indicated in Table 2.

### EXAMPLE 2

4.44 kg/h SiCl₄ are evaporated at approximately 130° C. and transferred into the central tube of the burner with a known design in accordance with DE 196 50 500 A1. 4.7 Nm³/h hydrogen as well as 3.7 Nm³/h air and 1.15 Nm³/h oxygen are additionally fed into this tube. This gaseous mixture flows out of the inner burner nozzle and burns into the combustion chamber of the water-cooled fire tube.

Additionally, 0.5 Nm³/h (secondary) hydrogen and 0.3 Nm³/h nitrogen are fed into the jacket nozzle surrounding the central nozzle in order to avoid cakings.

Approximately 10 Nm³/h air is drawn from the ambient into the fire tube standing under a slight vacuum (open burner operation).

The second gaseous component that is fed into the axial tube consists of an aerosol produced from a 12.55% aqueous solution of potassium chloride. Two gas-atomizing nozzles with an atomization power of 255 g/h aerosol function thereby as aerosol generator. This aqueous saline aerosol is conducted by 2 Nm³/h carrier air through externally heated conduits and leaves the inner nozzle with an exit temperature of approximately 180° C. The aerosol containing potassium salt is introduced into the flame.

After the flame hydrolysis the reaction gases and the pyrogenic silicic acid produced are drawn through a cooling system by applying a vacuum and the gaseous particle current cooled off thereby to approximately 100 to 160° C. The solid matter is separated from the current of waste gas in a filter or cyclone.

The pyrogenic silicic acid doped with potassium that is produced accumulates as white, fine powder. In a further step any adhering remnants of hydrochloric acid are removed from the silicic acid at an elevated temperature by a treatment with air containing water vapor.

The BET surface of the pyrogenic silicic acid is 131 m²/g.

The production conditions are summarized in Table 1. The analytical data of the silicic acid obtained is indicated in Table 2.

### EXAMPLE 3

4.44 kg/h SiCl₄ are evaporated at approximately 130° C. and transferred into the central tube of the burner with a known design in accordance with DE 196 50 500 A1. 4.7 Nm³/h hydrogen as well as 3.7 Nm³/h air and 1.15 Nm³/h oxygen are additionally fed into this tube. This gaseous mixture flows out of the inner burner nozzle and burns into the combustion chamber of the water-cooled fire tube.

Additionally, 0.5 Nm³/h (secondary) hydrogen and 0.3 Nm³/h nitrogen are fed into the jacket nozzle surrounding the central nozzle in order to avoid cakings.

Approximately 10 Nm³/h air is drawn from the ambient into the fire tube standing under a slight vacuum (open burner operation).

The second gaseous component that is fed into the axial tube consists of an aerosol produced from a 2.22% aqueous solution of potassium chloride. Two gas-atomizing nozzles with an atomization power of 210 g/h aerosol function thereby as aerosol generator. This aqueous saline aerosol is conducted by 2 Nm³/h carrier air through externally heated conduits and leaves the inner nozzle with an exit temperature of approximately 180° C. The aerosol is introduced into the flame and correspondingly alters the properties of the pyrogenic silicic acid produced.

After the flame hydrolysis the reaction gases and the pyrogenic silicic acid produced are drawn through a cooling system by applying a vacuum and the gaseous particle current cooled off thereby to approximately 100 to 160° C. The solid matter is separated from the current of waste gas in a filter or cyclone.

The pyrogenic silicic acid doped with potassium that is produced accumulates as white, fine powder. In a further step any adhering remnants of hydrochloric acid are removed from the silicic acid at an elevated temperature by a treatment with air containing water vapor.

The BET surface of the pyrogenic silicic acid is 104 m²/g.

The production conditions are summarized in Table 1. The analytical data of the silicic acid obtained is indicated in Table 2.

### EXAMPLE 4

4.44 kg/h SiCl₄ are evaporated at approximately 130° C. and transferred into the central tube of the burner with a known design in accordance with DE 196 50 500 A1. 4.7 Nm³/h hydrogen as well as 3.7 Nm³/h air and 1.15 Nm³/h oxygen are additionally fed into this tube. This gaseous mixture flows out of the inner burner nozzle and burns into the combustion chamber of a water-cooled fire tube.

Additionally, 0.5 Nm³/h (secondary) hydrogen and 0.3 Nm³/h nitrogen are fed into the jacket nozzle surrounding the central nozzle in order to avoid cakings.

Approximately 10 Nm³/h air is drawn from the ambient into the fire tube standing under a slight vacuum (open burner operation).

The second gaseous component that is fed into the axial tube consists of an aerosol produced from a 4.7% aqueous solution of potassium chloride. Two gas-atomizing nozzles with an atomization power of 225 g/h aerosol function thereby as aerosol generator. This aqueous saline aerosol is conducted by 2 Nm³/h carrier air through externally heated conduits and leaves the inner nozzle with an exit temperature of approximately 180° C. The aerosol is introduced into the flame.

After the flame hydrolysis the reaction gases and the pyrogenic silicic acid produced are drawn through a cooling system by applying a vacuum and the gaseous particle current cooled off thereby to approximately 100 to 160° C. The solid matter is separated from the current of waste gas in a filter or cyclone.

The pyrogenic silicic acid doped with potassium that is produced accumulates as white, fine powder. In a further step any adhering remnants of hydrochloric acid are removed from the silicic acid at an elevated temperature by a treatment with air containing water vapor.

The BET surface of the pyrogenic silicic acid is 113 m²/g.

The production conditions are summarized in Table 1. The analytical data of the silicic acid obtained is indicated in Table 2.

### EXAMPLE 5

4.44 kg/h SiCl₄ are evaporated at approximately 130° C. and transferred into the central tube of the burner with a known design in accordance with DE 196 50 500 A1. 4.7 Nm³/h hydrogen as well as 3.7 Nm³/h air and 1.15 Nm³/h oxygen are additionally fed into this tube. This gaseous mixture flows out of the inner burner nozzle and bums into the combustion chamber of a water-cooled fire tube.

Additionally, 0.5 Nm³/h (secondary) hydrogen and 0.3 Nm³/h nitrogen are fed into the jacket nozzle surrounding the central nozzle in order to avoid cakings.

Approximately 10 Nm³/h air is drawn from the ambient into the fire tube standing under a slight vacuum (open burner operation).

The second gaseous component that is fed into the axial tube consists of an aerosol produced from a 9.0% aqueous solution of potassium chloride. Two gas-atomizing nozzles with an atomization power of 210 g/h aerosol function thereby as aerosol generator. This aqueous saline aerosol is conducted by 2 Nm³/h carrier air through externally heated conduits and leaves the inner nozzle with an exit temperature of approximately 180° C. The aerosol is introduced into the flame.

After the flame hydrolysis the reaction gases and the pyrogenic silicic acid produced are drawn through a cooling system by applying a vacuum and the gaseous particle current cooled off thereby to approximately 100 to 160° C. The solid matter is separated from the current of waste gas in a filter or cyclone.

The pyrogenic silicic acid doped with potassium that is produced accumulates as white, fine powder. In a further step any adhering remnants of hydrochloric acid are removed from the silicic acid at an elevated temperature by a treatment with air containing water vapor.

The BET surface of the pyrogenic silicic acid is 121 m²/g.

The production conditions are summarized in Table 1. The analytical data of the silicic acid obtained is indicated in Table 2.

### EXAMPLE 6

4.44 kg/h SiCl₄ are evaporated at approximately 130° C. and transferred into the central tube of the burner with a known design in accordance with DE 196 50 500 A1. 4.7 Nm³/h hydrogen as well as 3.7 Nm³/h air and 1.15 Nm³/h oxygen are additionally fed into this tube. This gaseous mixture flows out of the inner burner nozzle and burns into the combustion chamber of a water-cooled fire tube.

Additionally, 0.5 Nm³/h (secondary) hydrogen and 0.3 Nm³/h nitrogen are fed into the jacket nozzle surrounding the central nozzle in order to avoid cakings.

Approximately 10 Nm³/h air is drawn from the ambient into the fire tube standing under a slight vacuum (open burner operation).

The second gaseous component that is fed into the axial tube consists of an aerosol produced from a 12.0% aqueous solution of potassium chloride. Two gas-atomizing nozzles with an atomization power of 225 g/h aerosol function thereby as aerosol generator. This aqueous saline aerosol is conducted by 2 Nm³/h carrier air through externally heated conduits and leaves the inner nozzle with an exit temperature of approximately 180° C. The aerosol is introduced into the flame.

After the flame hydrolysis the reaction gases and the pyrogenic silicic acid produced are drawn through a cooling system by applying a vacuum and the gaseous particle current cooled off thereby to approximately 100 to 160° C. The solid matter is separated from the current of waste gas in a filter or cyclone.

The pyrogenic silicic acid doped with potassium that is produced accumulates as white, fine powder. In a further step any adhering remnants of hydrochloric acid are removed from the silicic acid at an elevated temperature by a treatment with air containing water vapor.

The BET surface of the pyrogenic silicic acid is 120 m²/g.

The production conditions are summarized in Table 1. The analytical data of the silicic acid obtained is indicated in Table 2.

### EXAMPLE 7

4.44 kg/h SiCl₄ are evaporated at approximately 130° C. and transferred into the central tube of the burner with a known design in accordance with DE 196 50 500 A1. 4.7 Nm³/h hydrogen as well as 3.7 Nm³/h air and 1.15 Nm³/h oxygen are additionally fed into this tube. This gaseous mixture flows out of the inner burner nozzle and burns into the combustion chamber of a water-cooled fire tube.

Additionally, 0.5 Nm³/h (secondary) hydrogen and 0.3 Nm³/h nitrogen are fed into the jacket nozzle surrounding the central nozzle in order to avoid cakings.

Approximately 10 Nm³/h air is drawn from the ambient into the fire tube standing under a slight vacuum (open burner operation).

The second gaseous component that is fed into the axial tube consists of an aerosol produced from a 20% aqueous solution of potassium chloride. Two gas-atomizing nozzles with an atomization power of 210 g/h aerosol function thereby as aerosol generator. This aqueous saline aerosol is conducted by 2 Nm³/h carrier air through externally heated conduits and leaves the inner nozzle with an exit temperature of approximately 180° C. The aerosol is introduced into the flame.

After the flame hydrolysis the reaction gases and the pyrogenic silicic acid produced are drawn through a cooling system by applying a vacuum and the gaseous particle current cooled off thereby to approximately 100 to 160° C. The solid matter is separated from the current of waste gas in a filter or cyclone.

The pyrogenic silicic acid doped with potassium that is produced accumulates as white, fine powder. In a further step any adhering remnants of hydrochloric acid are removed from the silicic acid at an elevated temperature by a treatment with air containing water vapor.

The BET surface of the pyrogenic silicic acid is 117 m²/g.

The breadth of the distribution of the particle size is calculated as follows:

dₙ=20.99 nm

dₐ=24.27 nm

The quotient

$${q}_{1} = \frac{{d}_{n}}{{d}_{a}} = 0.86 .$$

The production conditions are summarized in Table 1. The analytical data of the silicic acid obtained is indicated in Table 2.

TABLE 1
Experimental conditions in the production of doped, pyrogenic silicic acid

| | | | | | | | | | | | |
|---|---|---|---|---|---|---|---|---|---|---|---|
| | | Primary | O₂ | H₂ | H₂ | N₂ | Gas | KCl saline | Aerosol | | |
| | SiCl₄ | Air | addit. | core | jacket | jacket | temp. | solution | amount | Air | BET |
| No. | kg/h | Nm³/h | Nm³/h | Nm³/h | Nm³/h | Nm³/h | C. | % by wt. | g/h | Nm³/h | m²/g |

Example 1 without addition of salt

| | | | | | | | | | | | |
|---|---|---|---|---|---|---|---|---|---|---|---|
| 1 | 4.44 | 3.8 | 0.25 | 2.9 | 0.3 | 0.3 | 130 | Only H₂O | 250 | 2 | 124 |

Examples 2 to 7 with addition of salt

| | | | | | | | | | | | |
|---|---|---|---|---|---|---|---|---|---|---|---|
| 2 | 4.44 | 3.7 | 1.15 | 4.7 | 0.5 | 0.3 | 130 | 12.55 | 255 | 2 | 131 |
| 3 | 4.44 | 3.7 | 1.15 | 4.7 | 0.5 | 0.3 | 130 | 2.22 | 210 | 2 | 104 |
| 4 | 4.44 | 3.7 | 1.15 | 4.7 | 0.5 | 0.3 | 130 | 4.7 | 225 | 2 | 113 |
| 5 | 4.44 | 3.7 | 1.15 | 4.7 | 0.5 | 0.3 | 130 | 9.0 | 210 | 2 | 121 |
| 6 | 4.44 | 3.7 | 1.15 | 4.7 | 0.5 | 0.3 | 130 | 12.0 | 225 | 2 | 120 |
| 7 | 4.44 | 3.7 | 1.15 | 4.7 | 0.5 | 0.3 | 130 | 20.0 | 210 | 2 | 117 |

Explanation: Primary air = amount of air in the central tube; H₂ core = hydrogen in the central tube; gas temp. = gas temperature at the nozzle of the central tube; aerosol amount = mass flux of the saline solution converted into aerosol form; air-aerosol = carrier gas amount (air) of the aerosol

TABLE 2
Analytical data of the doped silicic acids obtained according to
examples 1 to 7

| | | | | | | |
|---|---|---|---|---|---|---|
| | | | | DBP in | | |
| | | | Potassium | g/100 g | | |
| | | pH 4% | content in | with 16 g | Bulk | |
| | BET | aqueous | % by wt. | weighed | density | Stamping |
| No. | m²/g | dispersion | as K₂O | portion | g/l | density |

Reference example without salt

| | | | | | | |
|---|---|---|---|---|---|---|
| 1 | 124 | 4.68 | 0 | 185 | 28 | 39 |

Examples with addition of potassium salt

| | | | | | | |
|---|---|---|---|---|---|---|
| 2 | 131 | 7.64 | 0.44 | No end | 28 | 36 |
| | | | | point | | |
| 3 | 104 | 7.22 | 0.12 | No end | 31 | 43 |
| | | | | point | | |
| 4 | 113 | 7.67 | 0.24 | No end | 32 | 45 |
| | | | | point | | |
| 5 | 121 | 7.7 | 0.49 | No end | 32 | 43 |
| | | | | point | | |
| 6 | 120 | 7.96 | 0.69 | No end | 30 | 44 |
| | | | | point | | |
| 7 | 117 | 7.86 | 1.18 | No end | 28 | 38 |
| | | | | point | | |

Explanation: pH 4% sus. = pH of the 4% aqueous suspension; DBP = dibutylphthalate absorption

The subject matter of the invention is explained in detail with reference made to the drawings and figures:

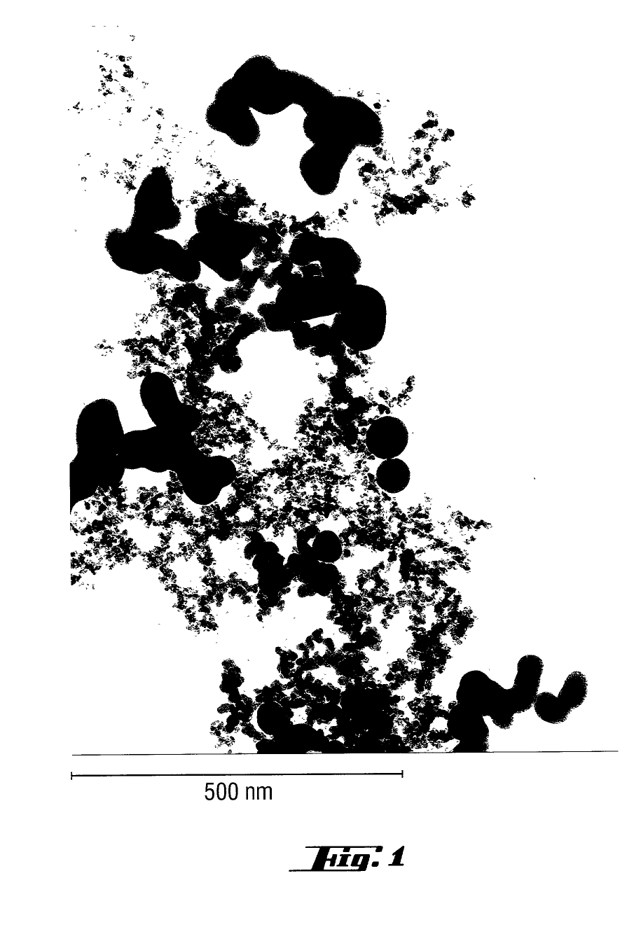

FIG. 1 shows an EM photograph of the pyrogenic silicic acid of reference example 1 (without doping).

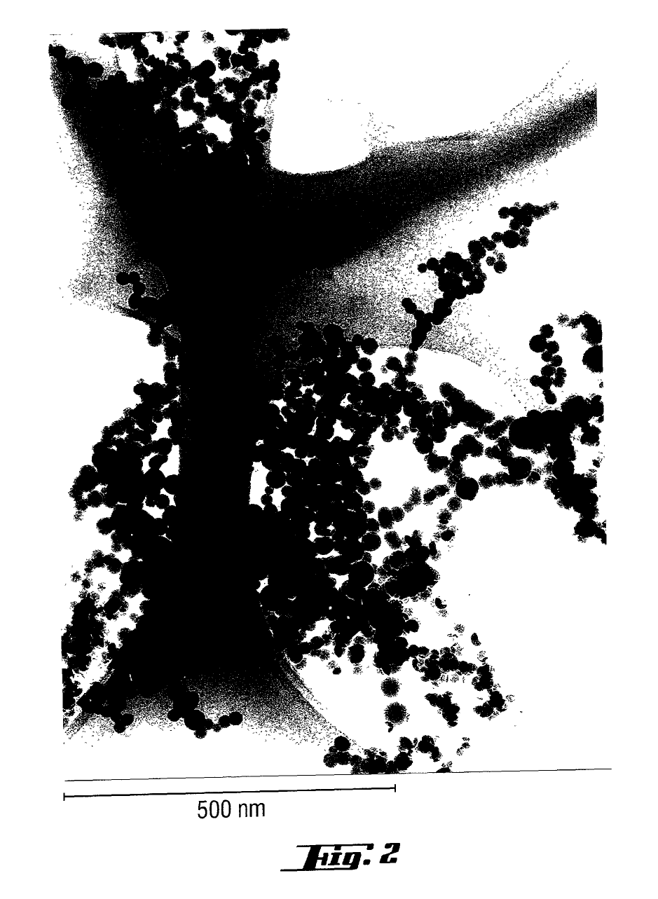

FIG. 2 shows an EM photograph of the pyrogenic silicic acid according to example 2 doped with potassium.

It can be recognized that the aggregate and agglomerate structure is changed during the doping with potassium salts and that spherical primary particles are produced during the doping that are not very intergrown with each other.

The differences in the “structure”, that is, the degree of intergrowth of the particles, are expressed in clearly different DBP absorptions (dibutylphthalate absorption) and in the different course of the DBP absorption curves.

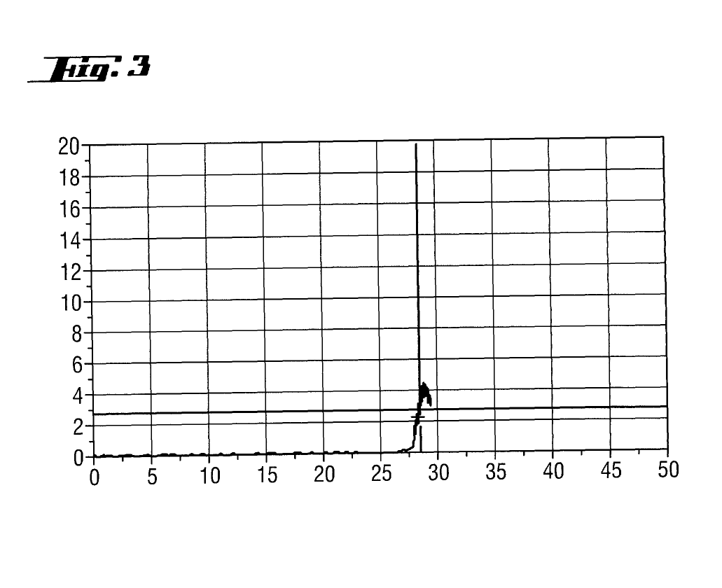

FIG. 3 shows the DBP curve of the powders of reference example 1 (weighed portion 16 g): The take-up of force and the measured torque (in Nm) of the rotating blades of the DBP measuring device (Rheocord 90 of the company Haake/ Karlsruhe) shows a sharply pronounced maximum with a subsequent decline at a certain addition of DBP. This curve form is characteristic for known pyrogenic oxides that are not doped.

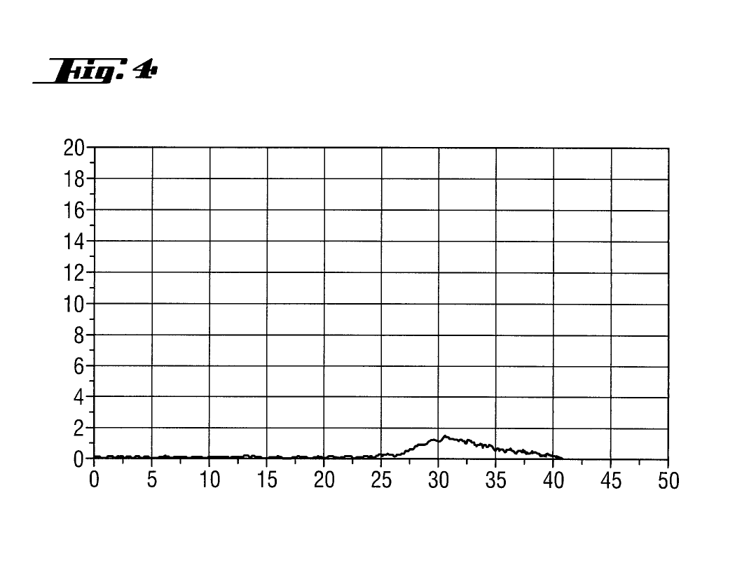

FIG. 4 shows the DBP curve of the powder of the pyrogenic oxide doped with potassium in accordance with the invention (16 g weighed portion) according to example 2.

No sharp rise of the torque with subsequent strong drop can be recognized. For this reason the DBP measuring device can also not detect an end point.

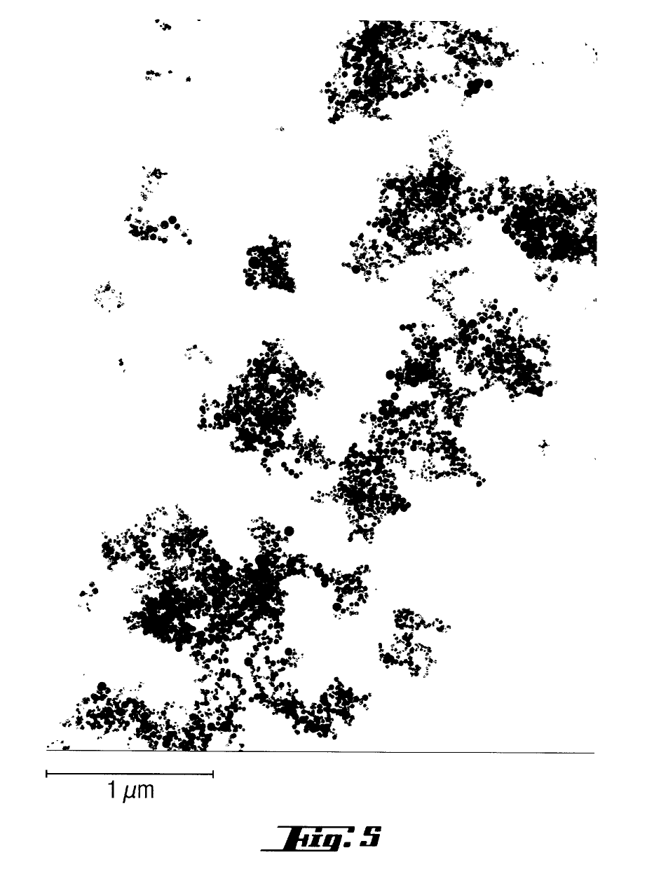

FIG. 5 shows the electron microscope photograph of the powder of example 3 with an enlargement of 1:50000.

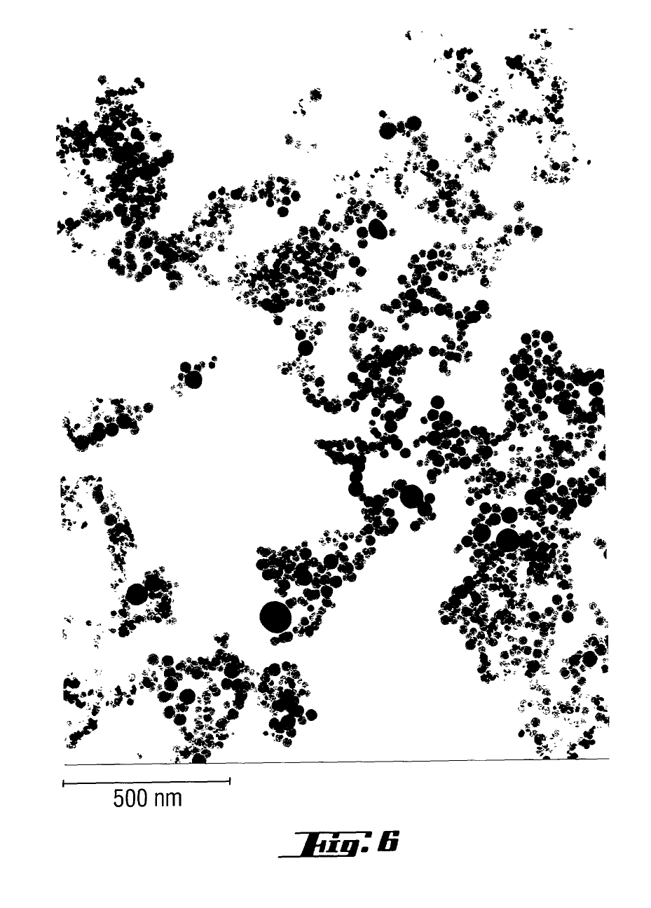

FIG. 6 shows the electron microscope photograph of the powder of example 3 with an enlargement of 1:100000.

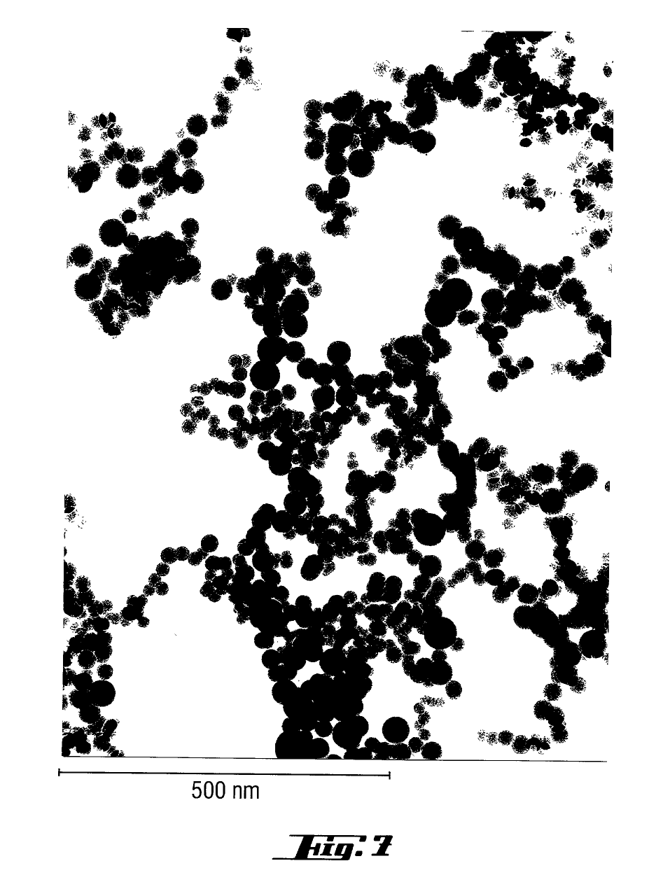

FIG. 7 shows the electron microscope photograph of the powder of example 3 with an enlargement of 1:200000.

The particle count by EM photography clearly shows the rather narrow particle distribution curve of the silicic acid doped by means of aerosol with potassium in accordance with the invention.

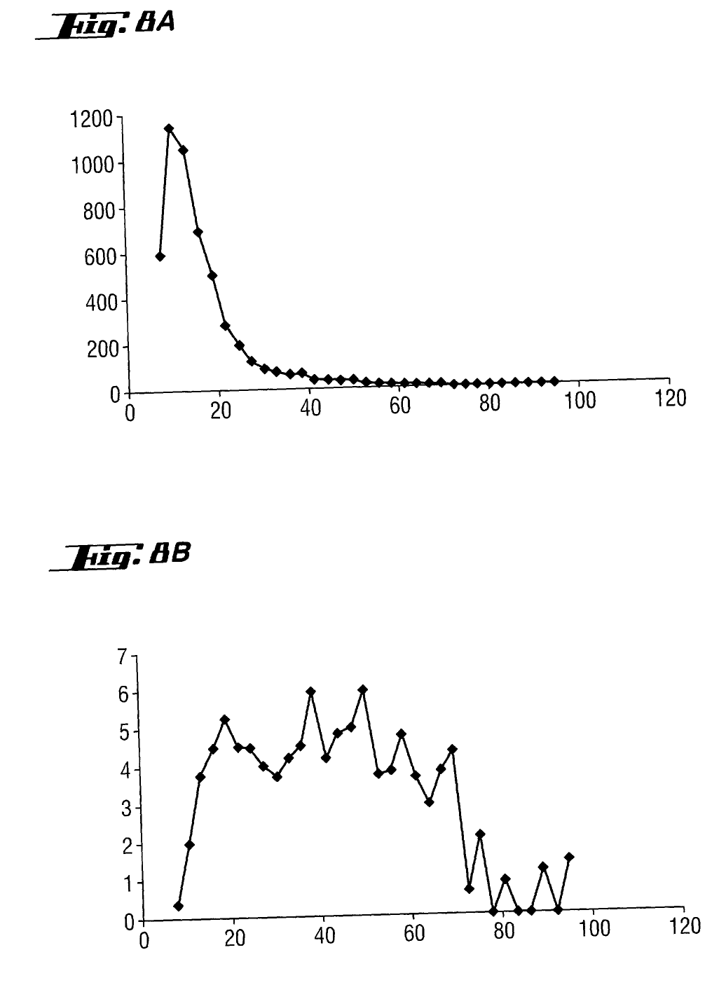

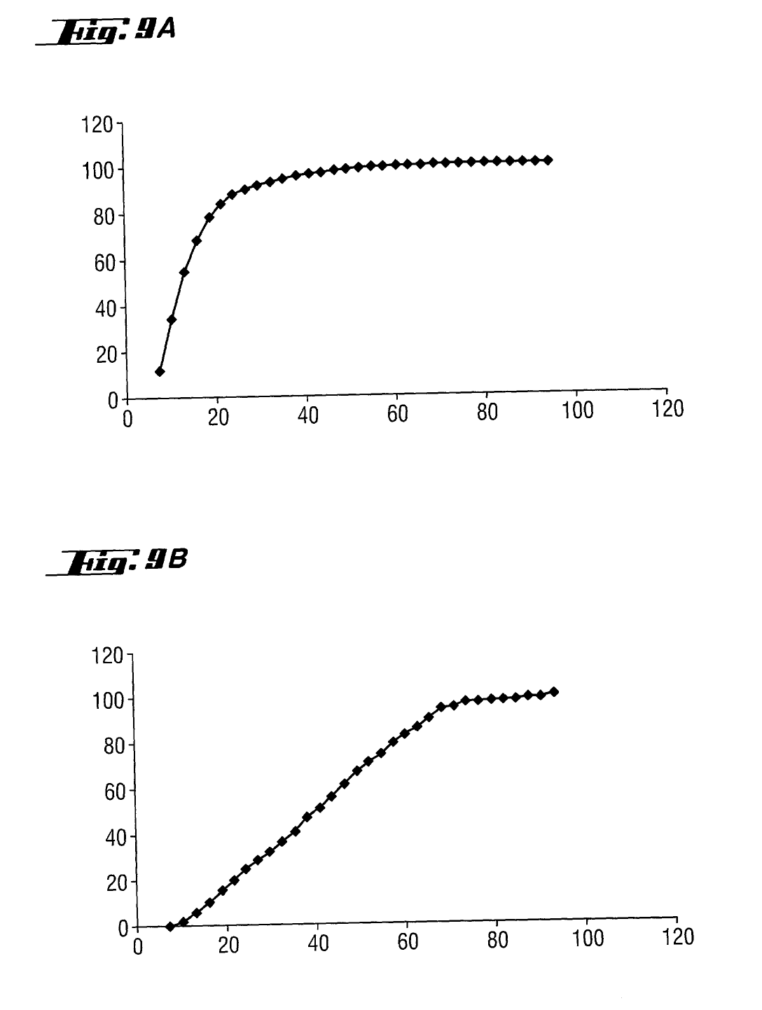

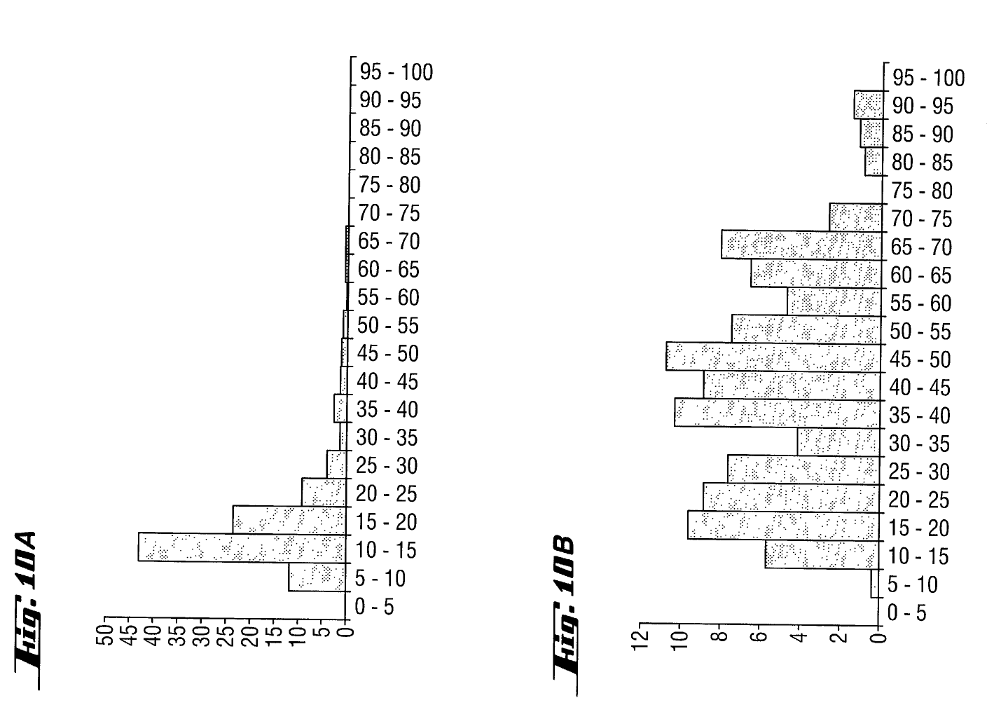

Table 3 shows the results of the particle count of the powders of example 1 (reference example) by means of the EM photograph. These values are graphically shown in FIGS. 8, 9 and 10.

TABLE 3

| | | |
|---|---|---|
| Total number of measured particles N: | 5074 | |
| Particle diameter, arithmetic mean DN: | 16.678 | nm |
| Particle diameter, average over the surface DA: | 31.825 | nm |
| Particle diameter, average over the volume DV: | 42.178 | nm |
| Particle diameter, standard deviation S: | 10.011 | nm |
| Particle diameter, co-efficient of variation V: | 60.027 | |
| Specific surface OEM: | 85.696 | qm/g |
| Median value numeric distribution D50 (A): | 12.347 | nm |
| Median value weight distribution D50 (g): | 40.086 | nm |

| 90% span numeric distribution: | | | | 3.166 nm-36.619 nm | |
|---|---|---|---|---|---|
| 90% span weight distribution | | | | 12.153 nm-72.335 nm | |
| Total span: | | | | 7.400 nm-94.200 nm | |
| | | Percent | Sum | | |
| | | by | Percent | Percent by | Sum |
| Diameter | Number | Number | by | weight | Percent by |
| D | N | N % | number | ND3 % | weight % |
| 7.400 | 593 | 11.687 | 11.687 | 0.393 | 0.393 |
| 10.200 | 1142 | 22.507 | 34.194 | 1.984 | 2.377 |
| 13.000 | 1046 | 20.615 | 54.809 | 3.761 | 6.138 |
| 15.800 | 693 | 13.658 | 68.467 | 4.474 | 10.612 |
| 18.600 | 498 | 9.815 | 78.281 | 5.245 | 15.857 |
| 21.400 | 281 | 5.538 | 83.819 | 4.507 | 20.364 |
| 24.200 | 193 | 3.804 | 87.623 | 4.477 | 24.841 |
| 27.000 | 124 | 2.444 | 90.067 | 3.995 | 28.836 |
| 29.800 | 86 | 1.695 | 91.762 | 3.725 | 32.561 |
| 32.600 | 74 | 1.458 | 93.220 | 4.196 | 36.757 |
| 35.400 | 62 | 1.222 | 94.442 | 4.502 | 41.259 |
| 38.200 | 65 | 1.281 | 95.723 | 5.930 | 47.189 |
| 41.000 | 37 | 0.729 | 96.453 | 4.174 | 51.363 |
| 43.800 | 35 | 0.690 | 97.142 | 4.814 | 56.176 |
| 46.600 | 30 | 0.591 | 97.734 | 4.969 | 61.145 |
| 49.400 | 30 | 0.591 | 98.325 | 5.919 | 67.065 |
| 52.000 | 16 | 0.315 | 98.640 | 3.725 | 70.789 |
| 55.000 | 14 | 0.276 | 98.916 | 3.812 | 74.602 |
| 57.800 | 15 | 0.296 | 99.212 | 4.741 | 79.343 |
| 60.600 | 10 | 0.197 | 99.409 | 3.642 | 82.985 |
| 63.400 | 7 | 0.138 | 99.547 | 2.920 | 85.905 |
| 66.200 | 8 | 0.158 | 99.704 | 3.799 | 89.703 |
| 69.000 | 8 | 0.158 | 99.862 | 4.301 | 94.005 |
| 71.800 | 1 | 0.020 | 99.882 | 0.606 | 94.611 |
| 74.600 | 3 | 0.059 | 99.941 | 2.039 | 96.649 |
| 80.200 | 1 | 0.020 | 99.961 | 0.844 | 97.494 |
| 88.600 | 1 | 0.020 | 99.980 | 1.138 | 98.632 |
| 94.200 | 1 | 0.020 | 100.000 | 1.368 | 100.000 |

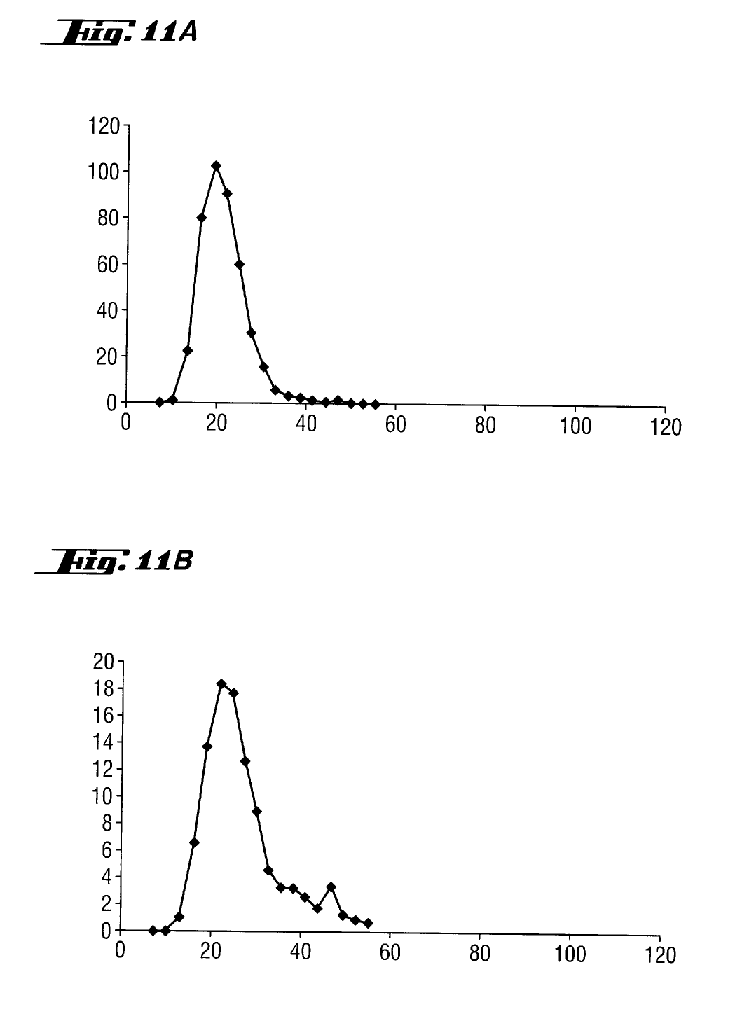

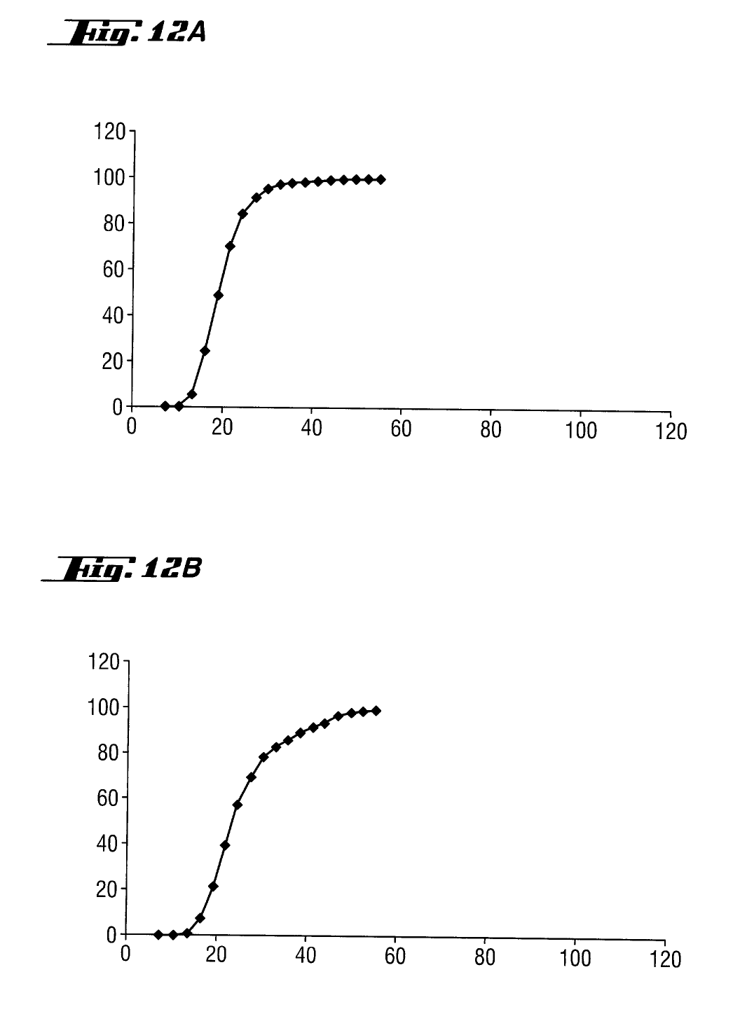

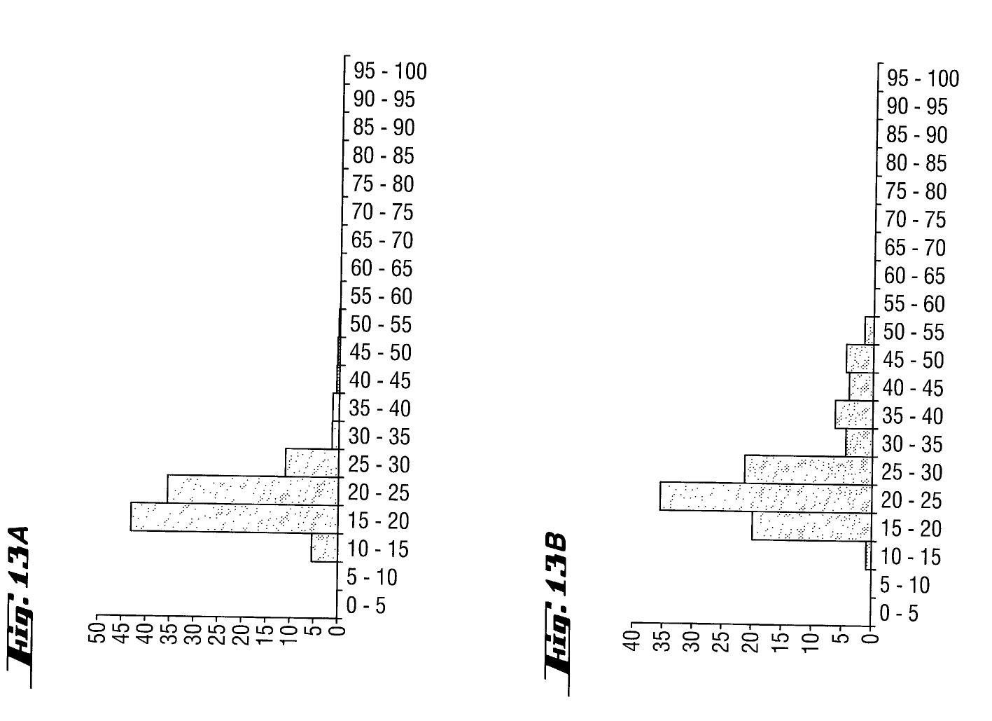

Table 4 shows the results of the particle count of the powders of example 7 by EM photograph. These values are graphically shown in FIGS. 11 to 13.

TABLE 4

| | | |
|---|---|---|
| Total number of measured particles N: | 4259 | |
| Particle diameter, arithmetic mean DN: | 20.993 | nm |
| Particle diameter, average over the surface DA: | 24.270 | nm |
| Particle diameter, average over the volume DV: | 26.562 | nm |
| Particle diameter, standard deviation S: | 5.537 | nm |
| Particle diameter, coefficient of variation V: | 26.374 | |
| Specific surface OEM: | 112.370 | qm/g |
| Median value numeric distribution D50 (A): | 18.740 | nm |
| Median value weight distribution D50 (g): | 23.047 | nm |

| | |
|---|---|
| 90% span numeric distribution: | 12.615 nm-29.237 nm |
| 90% span weight distribution | 14.686 nm-44.743 nm |
| Total span: | 7.400 nm-55.000 nm |

| | | Percent | | | |
|---|---|---|---|---|---|
| | | by | Sum | % by | Sum |
| Diameter | Number | Number | % by | weight | % by |
| D | N | N % | number | ND3 % | weight |
| 7.400 | 1 | 0.023 | 0.023 | 0.001 | 0.001 |
| 10.200 | 11 | 0.258 | 0.282 | 0.024 | 0.025 |
| 13.000 | 233 | 5.471 | 5.753 | 1.051 | 1.075 |
| 15.800 | 805 | 18.901 | 24.654 | 6.517 | 7.592 |
| 18.600 | 1034 | 24.278 | 48.932 | 13.656 | 21.248 |
| 21.400 | 913 | 21.437 | 70.369 | 18.364 | 39.613 |
| 24.200 | 607 | 14.252 | 84.621 | 17.656 | 57.269 |
| 27.000 | 311 | 7.302 | 91.923 | 12.564 | 69.833 |
| 29.800 | 164 | 3.851 | 95.774 | 8.908 | 78.740 |
| 32.600 | 63 | 1.479 | 97.253 | 4.480 | 83.220 |
| 35.400 | 35 | 0.822 | 98.075 | 3.187 | 86.407 |
| 38.200 | 28 | 0.657 | 98.732 | 3.203 | 89.610 |
| 41.000 | 18 | 0.423 | 99.155 | 2.546 | 92.156 |
| 43.800 | 10 | 0.235 | 99.390 | 1.725 | 93.881 |
| 46.600 | 16 | 0.376 | 99.765 | 3.323 | 97.204 |
| 49.400 | 5 | 0.117 | 99.883 | 1.237 | 98.441 |
| 52.200 | 3 | 0.070 | 99.953 | 0.876 | 99.317 |
| 55.000 | 2 | 0.047 | 100.000 | 0.683 | 100.000 |

1. Pyrogenically produced oxides of metals or metalloids which oxides are doped by means of aerosol with potassium, characterized in that the base component is an oxide that is pyrogenically produced in the manner of flame oxidation or preferably of flame hydrolysis and was doped with potassium from 0.000001 to 20% by wt. and in that the doping amount is preferably in a range of 1 to 20,000 ppm, the doping component is a salt of potassium, the BET surface of the doped oxide is between 1 and 1000 m²/g and the breadth of the distribution of particle size is at least 0.7.

2. Pyrogenically produced oxides of metals or metalloids which oxides are doped by means of aerosol with potassium in accordance with claim 1, characterized in that the base component is an oxide that is pyrogenically produced in the manner of flame oxidation or preferably of flame hydrolysis and was doped with potassium from 0.000001 to 20% by wt., that the pH of the doped, pyrogenic oxide is more than 5, measured in a 4% aqueous dispersion, and that the BET surface of the doped oxide is between 1 and 1000 m²/g.

3. Pyrogenically produced oxides of metals or metalloids which oxides are doped by means of aerosol with potassium in accordance with claim 1, characterized in that the base component is an oxide that is pyrogenically produced in the manner of flame oxidation or preferably of flame hydrolysis and was doped with potassium from 0.000001 to 20% by wt., that the doping amount is preferably in a range of 1 to 20,000 ppm and the absorption of dibutylphthalate does not allow any end point to be recognized, and that the BET surface of the doped oxide is between 1 and 1000 m²/g.

4. A method of producing pyrogenic oxides doped by means of aerosol with potassium according to claim 1, characterized in that an aerosol is fed into a flame like the one used to produce pyrogenic oxides in the manner of flame oxidation or preferably of flame hydrolysis, that this aerosol is homogeneously mixed before the reaction with the gaseous mixture of flame oxidation or flame hydrolysis, then the aerosol-gaseous mixture is allowed to react in a flame and the pyrogenic, potassium-doped oxides produced are separated in a known manner from the gas flow, that a potassium salt solution containing the potassium salt serves as starting product of the aerosol and that the aerosol is produced by atomization by means of an aerosol generator preferably in accordance with the gas-atomizing [two-fluid] nozzle method.

5. The use of pyrogenic oxides doped with potassium by means of aerosol in accordance with claim 1 as filler, carrier material, catalytically active substance, starting material for producing dispersions, as polishing material (CMP applications), base ceramic material, in the electronic industry, in the cosmetic industry, as additive in the silicon industry and rubber industry, for adjusting the rheology of liquid systems, for the stabilization of heat protection and in the paint industry.
